(19) United States
(12) Patent Application Publication
(10) Pub. No.: US 2016/0381447 A1
(43) Pub. Date: Dec. 29, 2016

(54) Ear Bud Holder

(71) Applicant: Albert A. Kattine, Nashville, TN (US)

(72) Inventor: Albert A. Kattine, Nashville, TN (US)

(21) Appl. No.: 14/749,074

(22) Filed: Jun. 24, 2015

(51) Int. Cl. H04R 1/10

(52) U.S. Cl. CPC H04R 1/105

(57) ABSTRACT

An ear bud holder that includes a lanyard, a clasp and first and second ear bud retainers. The lanyard has first and second sections with first and second ends and the clasp has first and second members. The first and second ends are attached to the first and second members, respectively. The clasp has a closed position, in which the first and second members are connected to each other, and an open position, in which the first and second members are detached. The first and second ear bud retainers are connected to the second ends of the first and second sections and include an adjustable loop adapted for securing an ear bud. After the ear buds are secured in the adjustable loops, the two members are connected behind the user's neck to prevent the ear buds from being lost and to conveniently keep them nearby when temporarily removed by the user.

### FIELD OF THE INVENTION

The present invention is a device for holding ear buds. In particular, the present invention relates to a device that is worn around the neck of a user and adjustably secured to one or more ear buds.

### BACKGROUND OF INVENTION

Listening to music using portable devices and lightweight headphones or ear buds has become increasingly popular as the devices have become smaller and the amount of music that can be stored on the devices has increased. Ear buds are small earphones that are inserted into the ears. In addition to their use with music playing devices, ear buds can also be used with portable (i.e., cell) phones. Typically, one ear bud is placed in each ear but it is also possible for a user to employ only one ear bud. One drawback of the in-ear design is that earphones or ear buds frequently fall out of the user's ear(s). This is particularly common while involved in strenuous activities or exercising, for example working-out at the gym, jogging or bicycling, where sweat may gather in the ear of the user, causing the ear buds to slip-out. Also, it may be desirable to remove the buds from the ears, but hold the in close proximity for future use, for instance when having a “live” conversation or between phone calls. Once removed from the ear, the earbuds can become detached from the portable device and lost or require the user to stop and retrace his or her path to retrieve them. In any event, such an occurrence is an inconvenience for the user and undesirable.

There are numerous ear buds currently being sold that are designed to remain securely positioned in the user's ears, either by wedging the ear buds in the user's ears or using a means, such as a clip, to attach the ear buds to the user's ears. However, these designs have been found to be either bulky or uncomfortable or both. Accordingly, there is a need for a device that prevents ear buds or the like from falling to the floor or ground and prevents the wires thereof from becoming entangled, while keeping them in close proximity when temporarily removed by the user and without sacrificing comfort, convenience, aesthetics or hygiene.

### SUMMARY OF THE INVENTION

In accordance with the present invention, an ear bud holder is provided. The ear bud holder includes a lanyard, a clasp and first and second ear bud retainers. The lanyard has a first section and a second section, wherein each section has a first end and a second end. The clasp has first and second members that are attached to the first and second sections. Preferably, at least one of the first and second members of the clasp includes a magnet and the members are magnetically connected to each other. The first and second members can have an outer surface made from rubber. The clasp has a closed position, in which the first and second members are connected to each other, and an open position, in which the first and second members are detached.

The first and second ear bud retainers are provided at the second ends of the first and second sections of the lanyard. The sections can be attached to the lanyard or formed by the lanyard. Preferably, each of the first and second ear bud retainers includes an adjustable loop adapted for securing an ear bud. More preferably, each adjustable loop includes a grommet having an annular body with a first side, a second side and an opening extending therebetween. The second end of the first or second section passes through the opening from the first side and forms the adjustable loop when the second end is attached to the grommet.

In a preferred embodiment, the first and second members of the clasp are adjustably attached to the first ends of the first and second sections of the lanyard. The first ends of the first and second sections pass through first and second adjustable apertures in the first and second members, respectively. Each of the adjustable apertures has an open position, in which the section of the lanyard passes freely through the adjustable aperture, and a closed position, in which the section of the lanyard cannot pass freely through the adjustable aperture. The adjustable members can include a spring biased stop that controls the open and closed positions of the adjustable aperture. After the first ends of the first and second sections pass through the adjustable apertures, a cap can be attached to each first end to prevent the first end from passing back through the adjustable aperture.

### BRIEF DESCRIPTION OF THE FIGURES

The preferred embodiments of the ear bud holder of the present invention, as well as other objects, features and advantages of this invention, will be apparent from the accompanying drawings wherein:

FIG. 1 is a top perspective view of a first embodiment of the ear bud holder of the present invention.

FIG. 2 is a detail view of the two adjustable loops at the second ends of the ear bud holder shown in FIG. 1.

FIG. 3 is a detail view of the clasp at the first ends of the ear bud holder shown in FIG. 1.

FIG. 4 is a top perspective view of a second embodiment of the ear bud holder of the present invention.

FIG. 5 is a detail view of the adjustable clasp members at the first end of the ear bud holder shown in FIG. 4.

FIG. 6 shows the ear bud holder shown in FIG. 1 with a pair of ear buds in the adjustable loops.

### DETAILED DESCRIPTION OF THE INVENTION

The present invention is an ear bud holder that is attached to one or two ear buds and worn around the neck of the user to prevent the ear buds from falling off the user. The ear bud holder includes a lanyard, adjustable loops for holding the ear buds and a clasp for attaching the ear bud holder around the user's neck. The ear bud holder is preferably made from soft, light-weight materials that are comfortable for the user to wear over extended periods of time.

As used herein, the term “lanyard” is defined as a cord or a thin rope formed by two or more detachable sections and worn around a person's neck. The lanyard can be formed from a variety of natural and synthetic materials such as cotton, hemp, nylon, silk and extruded elastomers. The type of material used to form the lanyard is not intended to limit the scope of the invention in any manner.

As used herein, the term “ear bud” is defined as a device inserted into the user's ear and functions as an earphone to transmit audio signals to the user. Ear buds are most commonly used for the transmission of voice and music and are generally made from a soft, pliable material, such as an elastomer, so that they can easily conform to the opening of the ear canal. However, the size and shape of the ear bud, the material that it is made from and the audio signal transmitted by it are not intended to limit the scope of the present invention in any manner.

As used herein, the term “clasp” is defined as a device formed by two members that is used for joining and securing the first and second sections of the lanyard. The two members can be any of the conventional devices used for joining a necklace or bracelet, such as a hook, buckle, ring, fastener or magnet. Preferably, the clasp has first and second members, which include metal components that are magnetically attracted to each other. When the two members are within a close proximity, they are magnetically attracted and attach to each other. The two members can be detached from each other by the application of a moderate amount of force to overcome the magnetic force.

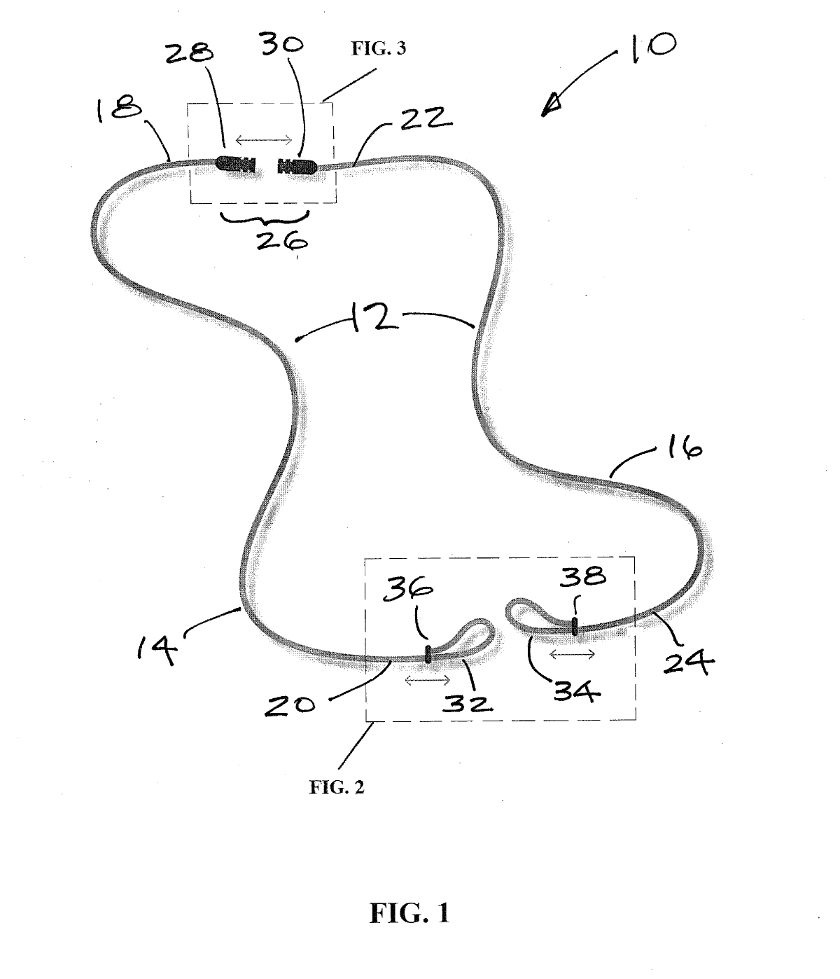

Referring now to the drawings, FIG. 1 shows a first embodiment of the ear bud holder 10 having a lanyard 12 with a first section 14 and a second section 16. The first section 14 of the lanyard 12 has a first end 18 and a second end 20 and the second section 16 of the lanyard 12 has a first end 22 and a second end 24. A clasp 26 connects the first end 18 of the first section 14 to the first end 22 of the second section 16. The clasp 26 is formed by a first member 28 attached to the first end 18 of the first section 14 and a second member 30 attached to the first end 22 of the second section 16. The second ends 20, 24 of the first and second sections 14, 16, respectively, have first and second adjustable loops 32, 34, respectively, which are formed using first and second grommets 36, 38.

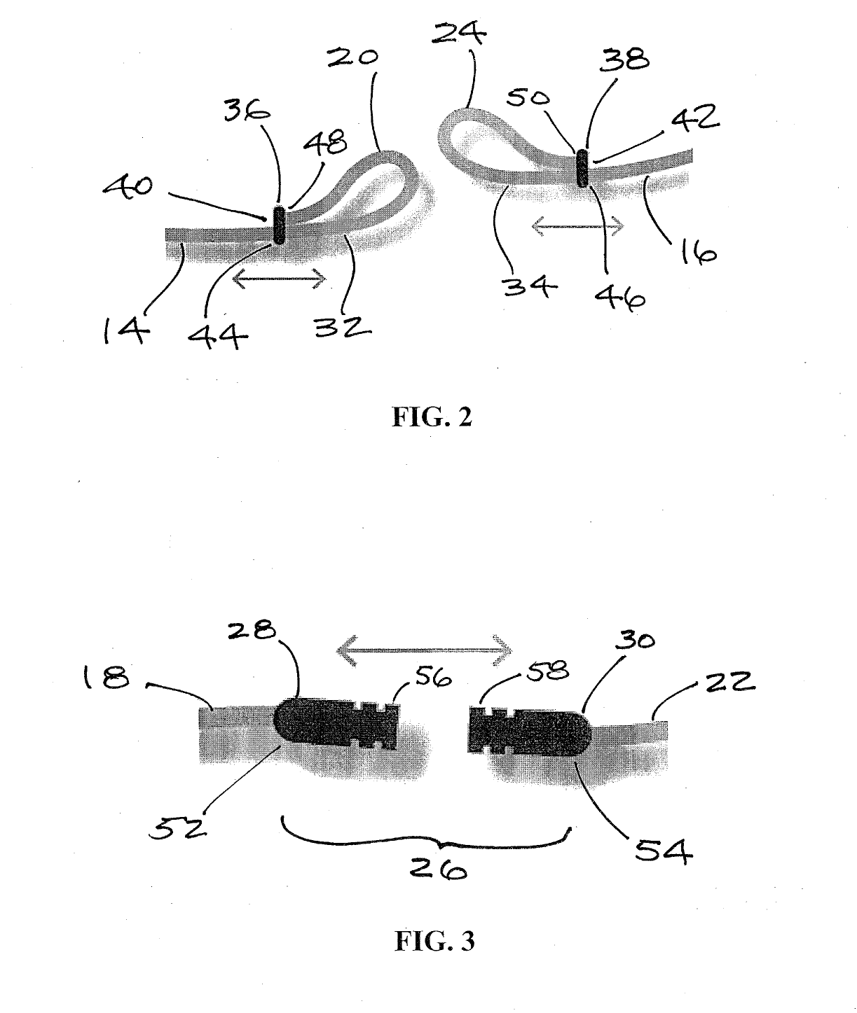

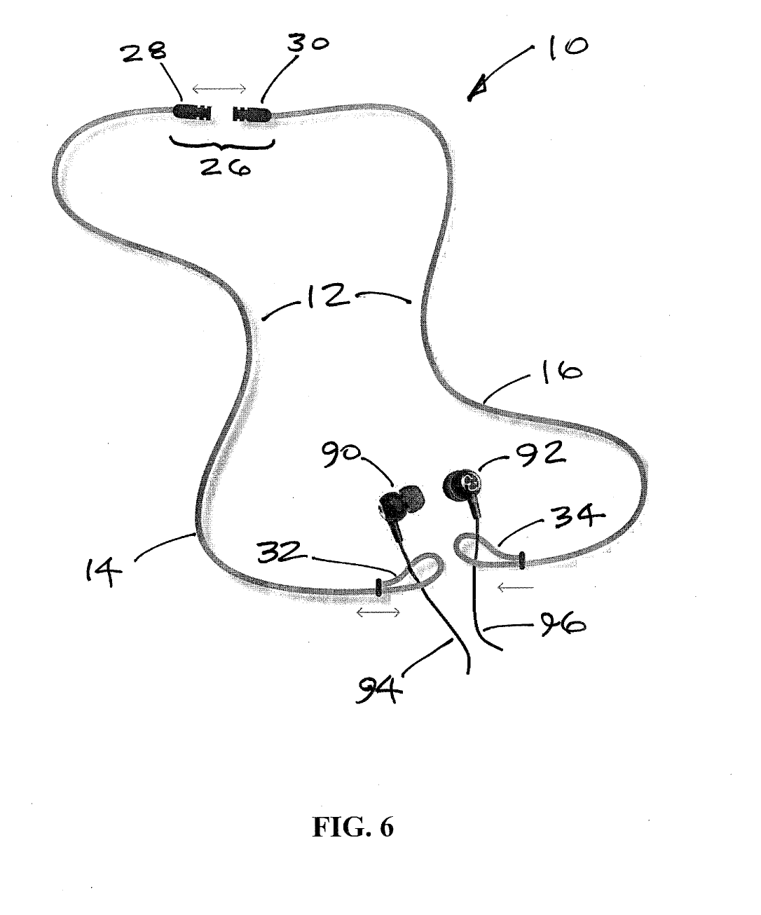

FIG. 2 shows a detail view of the loops 32, 34 located at the second ends 20, 24 of the first and second sections 14, 16, respectively. The first and second sections 14, 16 of the lanyard 12 pass through the openings 40, 42 in the two grommets 36, 38 from the first sides 44, 46 to the second sides 48, 50, respectively. After the first and second sections 14, 16 pass through the grommets 36, 38, the end is pulled through and attached to the second sides 48, 50 to form the loops 32, 34. After an ear bud 90 or 92 (see FIG. 6) passes through one of the loops 32 or 34, the grommet 36 or 38 is adjusted to reduce the size of the loop 32, 34 around the ear bud wire 94 or 96 so that the ear bud 90 or 92 cannot pass through the loop 32 or 34 and is secured by the ear bud holder 10.

FIG. 3 shows a detail view of the clasp 26 with a first member 28 attached to the first end 18 of the first section 14 and a second member 30 attached to the first end 22 of the second section 16. The housing or the outside surface of each of the members 28, 30 is formed by a pliable material, such as rubber, that can easily be gripped by the user and prevents the back of the user's neck from being chafed by the clasp 26. The proximal end of the members 28, 30 are attached to the first ends 18, 22 of the first and second sections 14, 18, respectively, of the lanyard 12 and the distal ends 56, 58 contain magnetic components that magnetically attach to each other.

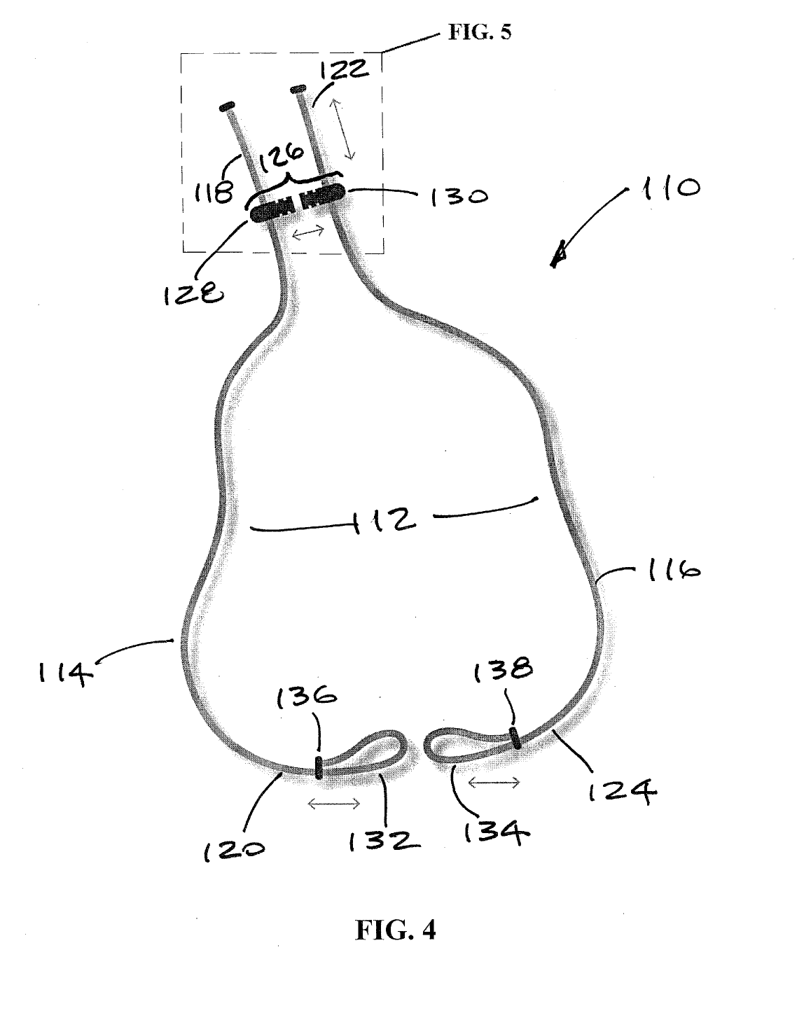

FIG. 4 shows a second embodiment of the ear bud holder 110 having a lanyard 112 with a first section 114 and a second section 116. The first section 114 of the lanyard 112 has a first end 118 and a second end 120 and the second section 116 of the lanyard 112 has a first end 122 and a second end 124. A clasp 126 connects the first section 114 to the second section 116 near the first and second ends 118, 120, respectively. The second ends 120, 124 of the first and second sections 114, 116, respectively, have first and second adjustable loops 132, 134, which are formed using first and second grommets 136, 138. The adjustable loops 132, 134 and grommets 136, 138 operate in the same manner as the adjustable loops 32, 34 and grommets 36, 38 in the first embodiment.

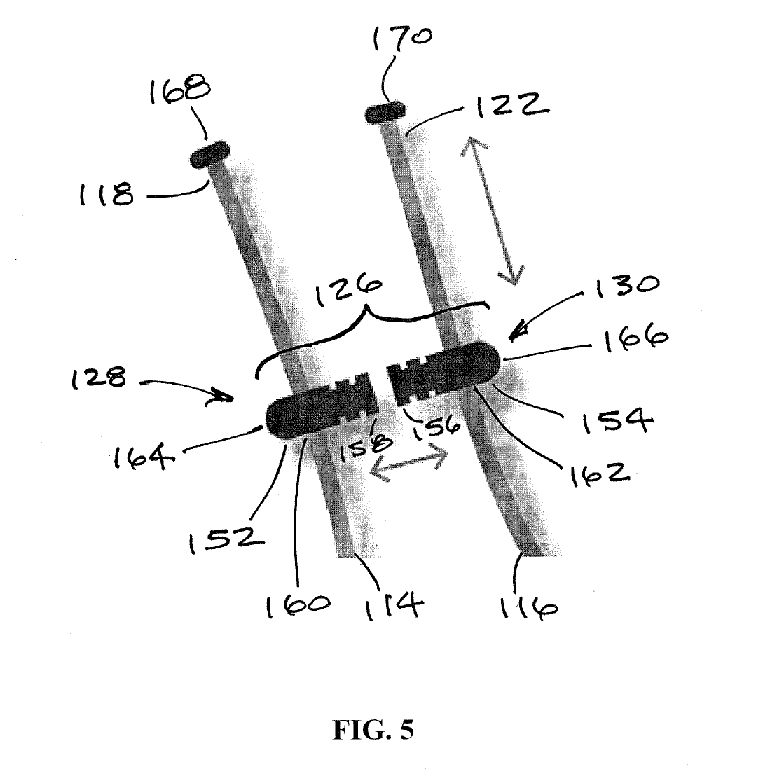

FIG. 5 shows a detail view of the clasp 126 in FIG. 4. The clasp 126 is formed by a first adjustable member 128 that is adjustably attached to the first section 114 of the lanyard 112 and a second adjustable member 130 that is adjustably attached to the second section 116. The first and second members 128, 130 have adjustable apertures 160, 162 with spring biased stops 164, 166 that regulate the size of the adjustable apertures 160, 162. The first ends 118, 122 of first and second sections 114, 116 pass through the adjustable apertures 160, 162 in the first and second adjustable members 128, 130. The spring biased stops 164, 166 have an open position and a closed position. In the open position, the first and second sections 114, 116 of the lanyard 112 freely pass through the adjustable apertures 160, 162. In the closed position, the first and second sections 114, 116 of the lanyard 112 are engaged by the spring biased stops 164, 166 and cannot pass through the adjustable apertures 160, 162. Caps 168, 170 are attached to the first ends 118, 122 of the first and second sections 114, 116, respectively, of the lanyard 112 that prevent the first and second sections 114, 116 from passing back through the adjustable apertures 160, 162 in the adjustable members 128, 130.

FIG. 6 shows the first embodiment of the ear bud holder 10 after two ear buds 90, 92 are inserted in the loops 32, 34 and prior to tightening the loops 32, 34 around the wires 94, 96. The ear buds 90, 92 can be installed in the ear bud holder 10 either before or after the lanyard 112 is placed around the neck of the user and secured by the clasp 26.

Thus, while there have been described the preferred embodiments of the present invention, those skilled in the art will realize that other embodiments can be made without departing from the spirit of the invention, and it is intended to include all such further modifications and changes as come within the true scope of the claims set forth herein.

I claim:

1. An ear bud holder comprising:
a lanyard having a first section and a second section, wherein each section has a first end and a second end;
a clasp having first and second members that are attached to the first and second sections, wherein the clasp has a closed position, in which the first and second members are connected to each other, and an open position, in which the first and second members are detached; and
a first ear bud retainer and a second ear bud retainer provided at the second ends of the first and second sections.

2. The ear bud holder according to claim 1, wherein at least one of the first and second members of the clasp comprises a magnet and the members are magnetically connected to each other.

3. The ear bud holder according to claim 1, wherein each of the first and second ear bud retainers comprises an adjustable loop adapted for securing an ear bud.

4. The ear bud holder according to claim 3, wherein each of the adjustable loops comprises a grommet having an annular body with a first side, a second side and an opening extending therebetween, and wherein the second end of the first or second section passes through the opening from the first side and forms the adjustable loop when the second end is attached to the grommet.

5. The ear bud holder according to claim 1, wherein each of the first and second members has outer surface made from rubber.

6. The ear bud holder according to claim 1, wherein the first and second members of the clasp are adjustably attached to the first ends of the first and second sections of the lanyard.

7. The ear bud holder according to claim 1, wherein the first ends of the first and second sections pass through first and second adjustable apertures in the first and second members, respectively, and wherein each of the adjustable apertures has an open position, in which the section of the lanyard passes freely through the adjustable aperture, and a closed position, in which the section of the lanyard cannot pass freely through the adjustable aperture.

8. The ear bud holder according to claim 8, wherein each of the adjustable members further comprises a spring biased stop, and wherein the spring biased stop controls the open and closed positions of the adjustable aperture.

9. The ear bud holder according to claim 7, wherein each of the first ends of the first and second sections has a cap that prevents the first end of the first or second section from passing freely through the adjustable aperture.

10. An ear bud holder comprising:
a lanyard having a first section and a second section, wherein each section has a first end and a second end;
a clasp having first and second members that are attached to the first and second sections, wherein at least one of the first and second members of the clasp comprises a magnet and the members are magnetically connected to each other, wherein the first and second members of the clasp are adjustably attached to the first ends of the first and second sections of the lanyard, and wherein the clasp has a closed position in which the first and second members are connected to each other and an open position in which the first and second members are detached; and
a first ear bud retainer and a second ear bud retainer connected to the second ends of the first and second sections, wherein each of the first and second ear bud retainers comprises an adjustable loop adapted for securing an ear bud.

11. The ear bud holder according to claim 10, wherein each of the adjustable loops comprises a grommet having an annular body with a first side, a second side and an opening extending therebetween, and wherein the second end of the first or second section passes through the opening from the first side and forms the adjustable loop when the second end is attached to the grommet.

12. The ear bud holder according to claim 10, wherein each of the first and second members has outer surface made from rubber.

13. The ear bud holder according to claim 10, wherein the first ends of the first and second sections pass through first and second adjustable apertures in the first and second members, respectively, and wherein each of the adjustable apertures has an open position, in which the section of the lanyard passes freely through the adjustable aperture, and a closed position, in which the section of the lanyard cannot pass freely through the adjustable aperture.

14. The ear bud holder according to claim 13, wherein each of the first ends of the first and second sections has a cap that prevents the first end of the first or second section from passing through the adjustable aperture.

15. An ear bud holder comprising:
a lanyard having a first section and a second section, wherein each section has a first end and a second end;
a clasp having first and second members that are attached to the first and second sections, wherein at least one of the first and second members of the clasp comprises a magnet and the members are magnetically connected to each other, wherein the clasp has a closed position in which the first and second members are connected to each other and an open position in which the first and second members are detached, wherein the first ends of the first and second sections pass through first and second adjustable apertures in the first and second members, respectively, and wherein each of the adjustable apertures has an open position, in which the section of the lanyard passes freely through the adjustable aperture, and a closed position, in which the section of the lanyard cannot pass freely through the adjustable aperture; and
a first ear bud retainer and a second ear bud retainer connected to the second ends of the first and second sections, wherein each of the first and second ear bud retainers comprises an adjustable loop adapted for securing an ear bud.

16. The ear bud holder according to claim 15, wherein each of the adjustable loops comprises a grommet having an annular body with a first side, a second side and an opening extending therebetween, and wherein the second end of the first or second section passes through the opening from the first side and forms the adjustable loop when the second end is attached to the grommet.

17. The ear bud holder according to claim 15, wherein each of the first and second members has outer surface made from rubber.

18. The ear bud holder according to claim 17, wherein each of the first ends of the first and second sections has a cap that prevents the first end of the first or second section from passing through the adjustable aperture.
